(19) United States
(12) Patent Application Publication
(10) Pub. No.: US 2010/0265327 A1
(43) Pub. Date: Oct. 21, 2010

(54) System for recording Surroundings

(76) Inventors: Wolfgang Niem, Hildesheim (DE); Henning Von Zitzewitz, Hildesheim (DE); Ulrich-Lorenz Benzler, Langenhagen (DE); Wolfgang Niehsen, Bad Salzdetfurth (DE); Anke Svensson, Braunschweig (DE); Jochen Wingbermuehle, Hemmingen (DE)

Correspondence Address: KENYON & KENYON LLP, ONE BROADWAY, NEW YORK, NY, 10004, US

(21) Appl. No.: 12/677,636

(22) PCT Filed: Aug. 25, 2008
(86) PCT No.: PCT/EP2008/061055

§ 371 Date: Jun. 30, 2010

(30) Foreign Application Priority Data
Sep. 12, 2007 (DE) 10 2007 043 534.9

(51) Int. Cl. H04N 7/18; G01S 19/39

(52) U.S. Cl. 348/135; 342/357.22; 348/E07.085

(57) ABSTRACT

A system and method to record the surroundings for a movable device. The system has at least one sensor for the visual recording of the surroundings, as well as respectively at least one sensor for recording the direction of motion and the orientation of the device, the system being developed to process information provided by the sensors.

### FIELD OF THE INVENTION

The present invention relates to a system for recording surroundings, a method for recording the surroundings, a computer program and a computer program product.

### BACKGROUND INFORMATION

In this instance, recording surroundings is typically provided for a mobile device which moves in the surroundings. The recorded surroundings may, among other things, be imaged cartographically, so that such a system is able to move automatically in the surroundings.

A system and a method for simultaneous visual location and imaging are described in PCT Application No. WO 2004/059900 A2. In this context, a visual sensor as well as a sensor for carrying out dead reckoning are used, to perform simultaneous location and imaging. Such a technique may be used for navigation of robots. It is further possible to generate and upgrade a map autonomously. In doing this, it is provided to compare and associate features of a landscape, which exist in an appropriate databank, with optically provided images of this landscape. While using dead reckoning, at least two provided pictures of the landscape are selected, and their landscape features are identified. In addition, location coordinates of these landscape features are determined. Subsequently, the location coordinates are connected to the landscape feature in such a way that navigation is possible.

### SUMMARY

A system according to an example embodiment of the present invention records the surroundings for a movable device. In this context, this example system has at least one sensor for visually recording the surroundings, as well as in each case at least one sensor for recording the direction of motion and the orientation of the device. Furthermore, the example system is developed to process data that are provided by the sensors.

This example system, or rather an appropriate device is suitable, for instance, for an autonomous and/or automatic device which moves automatically and, thus, independently in the surroundings or in a landscape. Such movable or mobile devices may be developed as robots. However, as the movable device, for example, a part of a robot, for instance a robot arm, may also be provided.

In one example embodiment, it is provided that the system be connected to the movable device. In this context, an exchange of information and data may take place between the system and the device. Moreover, it is particularly provided that the system carry out the same motions as the device. Accordingly, the system may collaborate with the device in such a way that the system, or at least individual components of the system, particularly the sensors, are situated in, at or on the device.

Since the example system records the surroundings of the movable device, the example system carries out for the movable device a location determination and/or the imaging or mapping of the surroundings in which the device is moving. Consequently, what happens, among other things, is that a map of the surroundings is provided using the system for the mobile device. Data for such a map may be stored using a suitable memory which may be associated with the system and/or the device. Using the stored data on the recorded surroundings, it is, among other things, possible to check the motions or the motion sequences of the device within the surroundings, and thus to regulate and/or control them. Using the data on the recorded surroundings, orientation and/or navigation of the device in the surroundings is possible. When the surroundings is recorded, as a rule, all spatial properties of the surroundings, including the presence of features, for instance, landscape features, which could possibly be developed as obstacles, are taken into account.

In one specific example embodiment of the present invention, the at least one sensor, which is provided for recording the preferably vectorial orientation or alignment of the movable device in space, is developed to provide information from a typically global reference, that is independent of the device. Accordingly, the sensor, or a corresponding module for recording the orientation, records data on the device that are provided by the global reference, that is superordinated with respect to recording of the movable device.

In this connection, the sensor for recording the orientation may be developed as a compass. Using a compass, it is possible to determine in which direction the device is oriented and/or is moving. In this case it is provided that, as an independent, global reference, the Earth's magnetic field is provided. As a rule, the vectorial orientation of the device is established by two reference points, or by one specified directional line, as in the case of the Earth's magnetic field.

Alternatively or in addition, the device may especially have at least one sensor developed as a GPS module, for recording the position and/or the direction of the device which determines a dwelling point of the device from the satellite-supported Global Positioning System.

Additional global references are also possible, however, according to which the at least one sensor for recording the orientation directs or orients itself. Thus, a location may also take place, for example, via a mobile radio network.

According to that, the device may also have two sensors that are at a distance from each other, for example, which each record a position based on GPS, and are thus developed as GPS modules. It is true, though, that an orientation derived from two positions measured in that way is inaccurate, since the two sensors developed as GPS modules are typically at a short distance apart, so that an exact differentiation of the recorded positions is difficult. Accordingly, within the scope of the present invention it is provided that one could use the orientation, and thus the direction, of the device based on a simply measurable field, such as the Earth's magnetic field, or usually a global reference which provides a two-dimensional, directionally pointing information to a spatial direction. It is also possible that the spatial orientation takes place based on at least two reference points. In the case of the Earth's magnetic field, or any other desired static or determinedly dynamic field, the at least two reference points are connected to each other by field lines.

It may be provided in one example embodiment, however, that the system have at least one GPS sensor or a GPS module, in supplementation. Using such a GPS sensor, which thus takes over a function as a sensor for recording a direction of the movable device, one is able to supplement the compass. Such a use of a GPS sensor is available if the Earth's magnetic field, that was to be recorded by the compass, should have interference by external electromagnetic fields. In this case, the GPS sensor is able to support or replace the function of the compass. In particular, when the device is moving, several positions may be determined using the GPS sensor in time sequence, and thus a direction of the motion may be recorded.

Via the at least one sensor for recording the orientation, which is developed as a compass, beyond making a pure determination of location, an orientation and alignment in space may also be provided for the movable device.

All in all, in one variant, the device may have at least one sensor for recording an attitude (pose), and thus for recording the orientation and direction and/or the position of the device in space.

It may furthermore be provided that the system also has a processing unit, such a processing unit cooperating with the sensors described in such a way that this processing unit combines the data provided by the sensors, that is, processes them contemporaneously and/or summarizing them in connection. In addition, such a processing unit may have the memory already described, or may at least cooperate with such a memory.

The present invention also relates to a method for recording the surroundings for a movable device, in this method, visual information on the surroundings, and furthermore information on the direction of motion and the orientation of the device being recorded; the recorded data being processed.

According to one variant of the method, the recorded data are processed together. On the visual information in this case, pictures, usually video takes or photographs of the surroundings are provided. This information is processed in common with the additional data on the direction of motion of the device, as well as the data on the orientation of the device.

Using the example method, a visual position finding and/or mapping of the surroundings, in which the device is moving, is able to be carried out. This may further mean that, based on a motion of the device in the surroundings, positions of features of the surroundings are determined, for instance, landscape markers, if the surroundings should happen to be developed as a landscape. Consequently, it is possible to carry out a visual location using the method.

By the combination of the visual information provided by the visual sensor and the data on the direction of motion provided by the at least one sensor for recording the direction of motion, as well as the data on the orientation, provided by the at least one sensor for recording the orientation, the recorded informations being linked to one another, it is possible to associate visual images of the landscape with an attitude, as a rule, the orientation and/or the position of the device. This further means that, depending on the suitable choice of a spatial reference system, even an attitude of a feature of the surroundings is able to be recorded. Using the at least one visual sensor, besides qualitative properties of the surroundings, which relate to a structure and thus to a positioning of features in the surroundings, one is also able to record quantitative properties, that is, distances, and consequently positions. Thus, the surroundings and the landscape are identified using the at least one visual sensor. A three-dimensional determination of the device's motion is enabled using the sensor for recording the direction of motion and the inertia and/or the torque. In addition, using the data on the direction of motion, one is able to carry out a support of the visualized location.

In an evaluation of the information recorded by the sensors, one may use, for instance, an algorithm for location and imaging based on probability, among other things, suitable estimates being made. While using optimizing and/or iterative methods, the recorded items of information may be adjusted to one another particularly by the processing unit, so that an image that is conclusive and free from contradiction and has a high resolution in detail, and consequently a mapping of the surroundings is possible.

It is provided that all the steps of the method, according to an example embodiment of the present invention, are able to be carried out by the system, according to an example embodiment of the present invention, or at least by individual modules of the system, according to an example embodiment of the present invention. Furthermore, individual functions of the system, or at least of individual components of the system, may also be implemented as steps of the method according to an example embodiment of the present invention.

In addition, the present invention relates to a computer program having program code for implementing all of the steps of a method according to the present invention, when the computer program is executed on a computer or a corresponding processing unit, in particular, a system according to the present invention.

The computer program product according to the present invention having program code, which are stored on a computer-readable data carrier, is designed to execute all of the steps of a method according to the present invention, when the computer program is executed on a computer or a corresponding processing unit, in particular a system according to the present invention.

In one embodiment the present method may be used for recording the surroundings for the visual location and imaging. Such techniques for imaging and location may be used in the field of movie camera tracking and mobile robot navigation, for instance, for providing a structure of a motion of a so-called simultaneous localization and mapping (SLAM), for image databank location, etc. In this context, at least one camera, particularly a perspective camera, may be used as the at least one visual sensor for the optical recording of features of the surroundings or landmarks in the surroundings of the movable, and thus mobile device.

In conventional procedures, one typically finds a combination of an optical sensor for dead reckoning, such as odometers or pedometers, via which a distance traveled may be determined so as to stabilize and perhaps to improve the visually provided information. However, such procedures are inaccurate. In conventional procedures there always comes about an accumulation of errors (drift), since resynchronization for location while taking into account a global, external reference is not possible.

Now, using the example embodiment of the present invention, an accurate location is possible as a function of time and/or a route which the movable device has traveled.

Such a location is able to be taken into account, in the example embodiment of the present invention, by the sensors for recording the orientation and/or the positioning of the device. This means that, by taking into account the external reference, that is, the reference situated outside the device and consequently independent of the device, a so-called attitude of the mobile device in three-dimensional space is able to be determined. According to DIN EN ISO 8373, an attitude is designated as a combination of position and/or orientation, in this context.

Within the scope of the present invention, it is provided, among other things, that by the combination of a far-field sight sensor as a visual sensor, such as a so-called fisheye camera, a panorama camera or a so-called Omnicam, with the at least one sensor for determining the direction of motion, for instance, with an inertia sensor, and particularly the compass system as a sensor for orientation, as components of the system, a visual location module is provided for the mobile device, the system only permitting a small error accumulation, but enabling great accuracy with respect to the location.

In one embodiment, for visual location, the system includes at least one far-field sight sensor as visual sensor, with which it is possible optically to record features or landscape markers of the surroundings over a long period of time and/or a great distance. Consequently, a large number of succinct features or landmarks may be used as a reference for location. This is particularly the case if new features are inserted in the imaging process, as is the case, for instance, in a so-called SLAM (simultaneous localization and mapping).

The accuracy of location of the system, or rather a system for visual location, may be improved by integration of sensors for dead reckoning. For this, for example, odometers or pedometers may be used for estimating a movement or a route traveled of a movable object.

However, in the present invention it is provided that, for this purpose, primarily sensors be used for determining the direction of motion, since these are also suitable for devices which have no wheels or legs. Furthermore, sensors for determining the direction of motion that are used in wheeled devices, such as in free surroundings, are not influenced by slipping or free spinning of the wheels. Since odometers or pedometers typically act together with wheels and legs, such sensors are particularly prone to inaccuracies in the sequence of motions. Such sensors are therefore commonly used in the embodiment of the device only as supplementary auxiliary devices. In the case of the sole use of odometers or pedometers there is the danger that false information is provided with respect to the route traveled. In addition, via sensors for determining the direction of motion, information on a motion in all three spatial directions may be recorded, whereas odometers or pedometers only supply information on a motion in a plane.

One disadvantage in conventional systems for location and imaging is that they are normally unable to detect a return to a place already visited. This may occur mainly by an accumulation of errors in the estimation of a direction of motion of a movable module. In the present invention, it is provided among other things that, while taking into account the external reference system, which takes place using the at least one sensor for orientation and positioning, if necessary, a location-determining synchronization of the system, and thus of the device, is possible. For this purpose, in one embodiment, the compass or a compass system is provided as a sensor for orientation and also for positioning, in order to prevent an accumulation of errors during a determination of a direction of motion by synchronization of the estimated or the calculated direction via the global reference system, for instance, the Earth's magnetic field, when using a magnetic compass. As a sensor for position finding or location, one may also, in supplement, draw upon a position-finding GPS module, which utilizes the satellite-supported global positioning system (GPS) as a global reference.

Devices for which the system and/or the method are suitable, typically have locomotion devices by which such devices are able to move in the surroundings. These locomotion devices may be developed as wheels, caterpillar chains or track chains or legs.

Additional advantages and refinements of the present invention are described below and are shown in the FIGURE.

It is understood that the features mentioned above and the features yet to be described below may be used not only in the combination given in each case but also in other combinations or individually, without departing from the scope of the present invention.

The present invention is represented schematically in the drawing based on an exemplary embodiment and is described in detail below with reference to the FIGURE.

### BRIEF DESCRIPTION OF THE DRAWING

FIG. 1 shows a specific embodiment of a system according to the present invention, which is developed as a component of a movable device, in a schematic representation.

### DETAILED DESCRIPTION OF EXAMPLE EMBODIMENTS

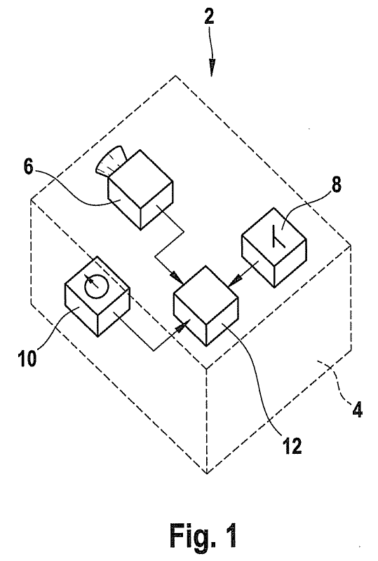

A specific embodiment of system 2, shown schematically in FIG. 1, is developed as a component of a movable device 4, which is shown as a dashed line in this case. System 2 includes a far-field sight camera, which is provided as a visual or optical sensor 6, a sensor 8 for determining a direction of motion of device 4, a sensor 10, developed as a compass, for determining the orientation of device 4, as well as a processing unit 12, which is developed for the fusion of data for the visual location and the imaging, within the scope of recording the surroundings in which device 4 is moving. System 2 for the visual localization is developed to utilize information, provided by visual sensor 6, for identifying features of the landscape, and thus also landmarks, as is provided within the scope of a procedure for location. In this context, visual sensor 6, that is provided here, has the capability to rerecognize features once recorded, so that it is possible, in an additional future recording, for these features to be correctly identified and be consequently recognized.

Using sensor 8 for determining the direction of motion, three-dimensional positions of the features of the surroundings are computed, based on a projection while taking into account properties of the pictures provided by visual sensor 6, and the motion recorded by sensors 8, 10 for determining the direction of motion and the orientation of device 4. In the present specific embodiment, this takes place utilizing a depth or a difference of the informations within the scope of a so-called “stereo from motion” computation.

After taking such initiating measurements, the features and their three-dimensional positions are computed together with a two-dimensional projection onto visual sensor 6 via an algorithm for the probability-based location and imaging, for instance, using a Kalman filter or a particle filter for the continuous estimation of position and direction (attitude) of device 4. Estimates of a direction of motion of device 4 are compared for consistency with the information recorded by sensor 10 for determining the orientation, in this context. A correction term for the orientation of device 4 is also generated, and used for stabilizing the estimate. During such a procedure for the continuous estimation, new features of the surroundings, and thus landmarks, are continually added, by system 2, to the algorithm for location and imaging. In addition, the quality of a rerecognition of already imaged, and therefore mapped features is constantly recorded, these repeatedly recorded features being removed from the algorithm for location and imaging, as required. Consequently, among other things, it is possible to enable a stable estimation to be made of the attitude of device 4 in a changing environment, and thus, changing surroundings.

In order to determine a direction in which device 4 is moving, system 2 may have at least one GPS sensor.

Present system 2 may be used for autonomous mobile platforms, such as vacuum cleaners, lawnmowers, transportation machines and the like. Moreover, the use in industrial robots is also possible, so that such robots are able to determine the location and the position of a robot arm. The use is also possible in automatic 3D measuring systems which, for example, are used for the automatic measurement of a space.

1-13. (canceled)

14. A system that is developed to record surroundings for a movable device, comprising:
at least one first sensor for visual recording of the surroundings;
at least one second sensor to record direction of motion of the device; and
at least one third sensor to record orientation of the device;
wherein the system is adapted to process information provided by the first, second and third sensors.

15. The system as recited in claim 14, wherein the at least one third sensor is adapted to provide information from a global reference that is independent of the device.

16. The system as recited in claim 14, which the system is connected to the device in such a way that the system carries out same motions as the device.

17. The system as recited in claim 14, wherein the at least one third sensor is a compass.

18. The system as recited in claim 14, further comprising:
at least one sensor to record a position of the device.

19. The system as recited in claim 14, further comprising:
at least one GPS sensor to record a direction of the device.

20. The system as recited in claim 14, further comprising:
at least one processing unit adapted to process the information provided by the first, second and third sensors in combined fashion.

21. A method to record surroundings for a movable device, comprising:
recording visual information on the surroundings, information on a direction of motion and on an orientation of the device; and
processing the recorded information.

22. The method as recited in claim 21, further comprising:
finding visual position, and mapping of surroundings.

23. The method as recited in claim 21, further comprising:
determining positions of features of the surroundings based on a motion of the device in the surroundings.

24. The method as recited in claim 21, further comprising:
using an algorithm for determining probability-based location and imaging.

25. A memory device storing a computer program having program code, the program code, when executed by a processor, causing the processor to perform the steps of:
recording visual information on the surroundings, information on a direction of motion and on an orientation of the device; and
processing the recorded information.

26. A computer-readable data carrier, storing program code, the program code, when executed by a processor, causing the processor to perform the steps of:
recording visual information on the surroundings, information on a direction of motion and on an orientation of the device; and
processing the recorded information.
